(19) United States
(12) Patent Application Publication
(10) Pub. No.: US 2020/0217246 A1
(43) Pub. Date: Jul. 9, 2020

(54) LENGTH-ADJUSTABLE CONNECTING ROD HAVING STOP SURFACES

(71) Applicant: AVL LIST GMBH, Graz (AT)

(72) Inventors: Norbert AUSSERHOFER, Graz (AT); Andreas KROBATH, St. Josef / Weststeiermark (AT); Harald PRAMBERGER, Graz (AT)

(21) Appl. No.: 16/338,071

(22) PCT Filed: Sep. 29, 2017
(86) PCT No.: PCT/EP2017/074841

§ 371 Date: Dec. 13, 2019

(30) Foreign Application Priority Data
Sep. 30, 2016 (AT) A50889/2016
Sep. 30, 2016 (AT) A50890/2016
Mar. 10, 2017 (AT) A50191/2017

(51) Int. Cl. F02B 75/04; F16C 7/06

(52) U.S. Cl. CPC F02B 75/045; F02D 15/02; F16C 7/06

(57) ABSTRACT

The invention relates to a length-adjustable connecting rod for a reciprocating piston engine, to a reciprocating piston engine, and to a vehicle having a reciprocating piston engine, wherein the connecting rod has a second connecting rod part with a guide cylinder, and a first connecting rod part with a guide shank, wherein the guide shank is accommodated by the guide cylinder and is movable relative thereto for adjustment of an effective connecting rod length, wherein the first connecting rod part has a first stop surface and the second connecting rod part has a second stop surface, wherein lying of the first stop surface against the second stop surface restricts a relative movement between the first connecting rod part and the second connecting rod part in a first direction, and wherein, when the first stop surface lies against the second stop surface, at least a portion of a compressive force acting on the connecting rod along the longitudinal axis of the connecting rod is transferred past the guide shank via the first stop surface and the second stop surface from the first connecting rod part into the second connecting rod part and/or vice versa.

The invention relates to a length-adjustable connecting rod for a reciprocating piston engine, in particular for a reciprocating piston internal combustion engine, wherein the connecting rod comprises at least one first connecting rod part and one second connecting rod part, whereby the second connecting rod part has a section with a guide cylinder on its end facing the first connecting rod part, whereby the first connecting rod part has a guide shank corresponding in form to the guide cylinder on its end facing the second connecting rod part, wherein the guide shank of the first connecting rod part is at least partly accommodated by the guide cylinder in a functional state of use of the connecting rod and is movable relative to same, in particular along a longitudinal axis of the connecting rod, for adjusting an effective length of the connecting rod.

The present invention further relates to a reciprocating piston engine, in particular a reciprocating piston internal combustion engine, having at least one length-adjustable connecting rod as well as a vehicle with a reciprocating piston engine, in particular a reciprocating piston internal combustion engine.

A connecting rod commonly and also in the context of the invention refers to the rod-like connecting element which in a reciprocating piston engine serves to connect the crankshaft to a reciprocating piston. The connecting rod thereby serves to convert a linear motion of the reciprocating piston, in particular a linearly oscillating axial motion of the reciprocating piston, which usually relates to a power or working piston, into a circular movement of the crankshaft, or, conversely, a circular motion of the crankshaft into a linear movement of the reciprocating piston.

A crankshaft in the sense of the invention refers to a shaft which is designed to preferably convert, particularly by means of connecting rods, the linearly oscillating motion in a reciprocating piston engine, in particular the translational motion, of one or more reciprocating pistons into a rotational movement or, conversely, a rotational motion into a translational movement.

To connect to the reciprocating piston and the crankshaft, the connecting rod normally exhibits a connecting rod bearing at both its respective ends, usually in the form of a connecting rod eye, whereby the connecting rod usually has a smaller connecting rod eye on the piston-side end and a larger connecting rod eye on the crankshaft-side end in terms of the functional installed state of a connecting rod in a reciprocating piston engine. A reciprocating piston can then be connected at the piston-side end of the connecting rod via a piston pin seated in the small connecting rod eye. The connecting rod can be connected to the crankshaft via the larger connecting rod eye, wherein a connecting rod bearing designed as a sliding bearing able to be lubricated with hydraulic medium, in particular with the engine oil of a reciprocating piston engine, is typically disposed in the large connecting rod eye.

The connecting rod is thereby in each case rotatably mounted about a rotational axis around the crankshaft and the piston pin, wherein the distance between the two axes of rotation define an operative or respectively effective connecting rod length. Changing the effective connecting rod length, in particular by adjusting the effective connecting rod length, can change the compression ratio in a reciprocating piston engine since the change in effective connecting rod length effects a shift in the piston top dead center.

Length-adjustable connecting rods are thus in particular used in reciprocating piston engines of variable compression ratio in order to regulate the compression ratio. Changing the compression ratio by changing the effective connecting rod length is generally known from the prior art, e.g. DE 10 2012 020 999 A1 or WO 2015/055582 A2.

The length-adjustable connecting rod described in DE 10 2012 020 999 A1 exhibits an eccentric arranged in the small connecting rod eye, whereby two hydraulic cylinders for adjusting the eccentric which can be supplied hydraulic medium from the engine oil of the reciprocating piston engine are provided at least partly external of the connecting rod shaft. For controlling the two hydraulic cylinders, and thus for adjusting the length of the connecting rod, a control device having two valves is provided which can supply the two respective hydraulic cylinders with hydraulic medium so as to set the desired change in the connecting rod length.

A length-adjustable connecting rod having a hydraulic length-adjusting device with a hydraulic cylinder disposed within the connecting rod is known from WO 2015/055582 A2, wherein the connecting rod has a first connecting rod shaft section and a second connecting rod shaft section which are displaceable along a longitudinal axis of the connecting rod relative to one another and in particular can be telescopically pushed into and out of each other. One of the two connecting rod shaft sections thereby forms the hydraulic cylinder of the length-adjusting device and the other connecting rod shaft section an associated hydraulic piston. A hydraulically actuatable control device having a single-acting adjusting piston which is axially displaceable in a longitudinal center plane of the connecting rod perpendicular to the crankshaft axis is provided as an adjusting element for controlling the length-adjusting device. In a functional state of use of the connecting rod in a reciprocating piston engine, the adjusting piston is axially displaceable from a first set position into a second set position against a restoring force generated by a return spring via the acting engine oil pressure in an associated reciprocating engine, whereby one or more hydraulic inflows/outflows of the hydraulic length-adjusting device are enabled or blocked depending on the set position of the adjusting piston. The degree of engine oil pressure which will effect a displacement of the adjusting piston from the first set position into the second set position can be regulated by means of the spring constant of the return spring.

Various concepts for adjusting the length of a connecting rod are known from the prior art, particularly different concepts for the controlling of such a length-adjusting device as well as different concepts related to the design of the connecting rod itself.

Among others, one challenge involved with length-adjustable connecting rods is that of achieving the necessary stability for the connecting rod for operation in a reciprocating piston engine, in particular a reciprocating piston internal combustion engine for a vehicle.

A further challenge moreover is constantly maintaining an adjusted effective connecting rod length over a defined period of time in order to be able to set a constant compression ratio over the defined time period.

It is thus a task of the invention to provide an alternative length-adjustable connecting rod for a reciprocating piston engine, preferably an improved length-adjustable connecting rod, in particular a connecting rod with which the necessary connecting rod stability can be achieved without a significant increase in weight and/or its effective connecting rod length can be kept constant over a longer defined period of time. Moreover a task of the invention is providing an alternative reciprocating piston engine, in particular an improved reciprocating piston engine, as well as an alternative vehicle, in particular an improved vehicle, having a reciprocating piston engine.

The invention solves these tasks by the teachings of the independent claims. Preferential further developments of the invention constitute the subject matter of the subclaims and will be described in greater detail in the following. The wording of the claims is hereby incorporated into the content of the description.

In an inventive connecting rod, the first connecting rod part comprises a first stop surface and the second connecting rod part a second stop surface, wherein the first stop surface lying against the second stop surface restricts a relative movement in a first direction. In particular, the connecting rod is designed such that when the first stop surface lies against the second stop surface, in particular at minimum effective connecting rod length, at least a portion of compressive force acting on the connecting rod along the longitudinal axis of the connecting rod is transferred past the guide shank via the first stop surface and the second stop surface from the first connecting rod part into the second connecting rod part and/or vice versa.

The two inventively provided stop surfaces give the inventive connecting rod the advantage of at least a portion of compressive force acting on the connecting rod along the longitudinal axis of the connecting rod being able to be transferred from the first connecting rod part into the second connecting rod part and/or vice versa past the guide shank, in particular at a minimum effective connecting rod length; i.e. particularly a maximum “compressed state” of the connecting rod. Compressive force acting on the guide shank can thereby be reduced and the load on the guide shank lessened. In particular, the risk of guide shank buckling can be reduced, in some cases even completely prevented.

As a result, the guide shank can be dimensioned smaller. In particular, a smaller guide shank cross section can be selected over at least a part of its length such that the guide shank requires less space in said area, thereby allowing a more advantageous design of a hydraulic length-adjusting device to be realized.

The guide cylinder of a length-adjustable connecting rod according to the invention can be designed as a vertical circular cylinder or alternatively as a general cylinder. In other words, that means that the guide cylinder of an inventive length-adjustable connecting rod can exhibit a circular cross section or a cross section deviating from circular form over its axial length, in particular any cross-sectional shape, and be of oblique or vertical cylinder configuration. Important is only that the guide cylinder and the guide shank are configured, in particular correspond to one another, such that the functionality needed for adjusting the effective connecting rod length can be achieved.

Preferably, the guide cylinder of an inventive length-adjustable connecting rod is designed as a general hollow cylinder having at least one surface area, in particular as a vertical hollow cylinder with a surface area arranged normal to a longitudinal axis of the hollow cylinder. Preferably, the longitudinal axis of the guide cylinder thereby coincides with the longitudinal axis of the connecting rod. Particularly preferential is for the surface area of the hollow cylinder to be of circular or rectangular configuration. Yet in principle, the surface area can be of any geometry. The hollow cylinder is preferably of open or at least partially closed design. The guide cylinder being at least partially of beaker-shaped or blind hole-shaped form is particularly preferential.

Preferably, the first connecting rod part, in particular the guide shank of the first connecting rod part, is displaceably supported in the second connecting rod part, in particular in the guide cylinder, whereby preferably the guide shank of the first connecting rod part can be pushed at least partly into the guide cylinder of the second connecting rod part and/or pulled out of same to adjust the effective connecting rod length. Preferably, the first connecting rod part and the second connecting rod part are telescopically displaceable relative to each other to adjust the effective connecting rod length, wherein a telescopic displacement relative to each other in the sense of the invention is to be understood as an inward/outward telescoping along a common displacement axis, in particular without one or more of the associated components rotating about the displacement axis. Advantageous in some cases is for the guide shank and the guide cylinder to be able to be telescopically pushed together or pulled apart.

It can also be advantageous in some cases for the guide shank and the guide cylinder to be able to be pushed together or pulled apart in spindle-like manner, in particular relative to each other along a common displacement axis with the guide shank and/or guide cylinder rotating about the displacement axis. In this case, however, the connecting rod is preferably designed such that the first connecting rod part and second connecting rod part do not thereby rotate around the displacement axis but rather only move relative to each other along same; i.e. only translationally. This can be achieved by means of an appropriate guide shank and/or guide cylinder bearing in the respectively associated connecting rod part.

In one advantageous configuration of an inventive connecting rod, the connecting rod is designed such that the first stop surface lying against the second stop surface restricts a relative motion between the first connecting rod part and the second connecting rod part effecting a shortening of the effective connecting rod length. In particular, an inventive connecting rod is designed such that the first stop surface lying against the second stop surface restricts a telescoping of the first connecting rod part and second connecting rod part and thus a shortening, in particular a (further) shortening of the effective connecting rod length.

In a further advantageous configuration of an inventive connecting rod, the first connecting rod part and/or the second connecting rod part comprises at least one element of a connecting rod bearing, preferably a connecting rod eye, whereby the first connecting rod part is in particular constructed to connect to a reciprocating piston of a reciprocating piston internal combustion engine. The second connecting rod part is in particular constructed connect to a crankshaft of a reciprocating piston internal combustion engine. Preferably, the first connecting rod part comprises a smaller connecting rod eye which in particular forms a piston pin bearing. The second connecting rod part preferably comprises a larger connecting rod eye which in particular serves as a crankshaft bearing.

For connecting to a reciprocating piston of a reciprocating piston engine, in particular a reciprocating piston internal combustion engine, the first connecting rod part can preferably be connected to the reciprocating piston of a reciprocating piston engine by means of a piston pin in a manner commonly known from the prior art, in particular by means of a connecting rod eye. Alternatively, the first connecting rod part can be fixedly connected to a piston pin, whereby a reciprocating piston of a reciprocating piston engine to be connected to the connecting rod in this case exhibits a corresponding eye by which the piston pin fixedly connected to the connecting rod can be received and in which the piston pin fixedly connected to the connecting rod can in particular be supported.

The second connecting rod part is preferably designed for connecting to a crankshaft of a reciprocating piston engine and can preferably be connected to the crankshaft by means of a large connecting rod eye, as is common in the prior art.

In a further advantageous configuration of a connecting rod according to the invention, the connecting rod comprises a hydraulic length-adjusting device for adjusting the effective connecting rod length, whereby the length-adjusting device preferably comprises at least one hydraulic cylinder with a piston, a first hydraulic working chamber and a second hydraulic working chamber, wherein the piston of the length-adjusting device is in particular part of the first connecting rod part and the hydraulic cylinder in particular part of the second connecting rod part.

The length-adjusting device of a connecting rod according to the invention can in principle be designed in a host of different ways, one example being the length-adjusting devices described in WO 2015/055582 A2, whereby reference is made to the aforementioned document for further details regarding the possible designs as well as the operating principles of length-adjusting devices applicable to a connecting rod according to the invention.

In a further advantageous configuration of an inventive connecting rod, the guide cylinder forms the hydraulic cylinder of the length-adjusting device and the guide shank the piston in an inventive connecting rod, whereby the piston of the length-adjusting device, in particular the guide shank, divides the hydraulic cylinder of the length-adjusting device into the first hydraulic working chamber and the second hydraulic working chamber.

In a further advantageous configuration of an inventive connecting rod, the guide shank is preferably designed as a double-acting piston, in particular as a double-acting stepped piston, and comprises a first effective hydraulic surface and a second effective hydraulic pressure surface, wherein the first effective hydraulic surface is allocated to the first hydraulic working chamber of the length-adjusting device and the second effective hydraulic surface of the stepped piston to the second hydraulic working chamber. The second effective hydraulic surface is thereby preferably arranged in particular on the opposite side of the guide shank from the free end of the guide shank. In particular, the size of the second effective hydraulic surface is at least 0.3 times, preferably at least 0.4 times, particularly at least 0.5 times, preferably at least 0.6 times that of the first effective hydraulic surface.

When operating in a reciprocating piston engine, in particular in a reciprocating piston internal combustion engine, high hydraulic operating pressures arise in the two hydraulic working chambers of the length-adjusting device during a working stroke, this placing high demands on the sealing of the length-adjusting device's hydraulic working chambers. The smaller the available hydraulic working surface, the larger the resulting pressures from compressive and/or tensile forces. Even small leakage; i.e. just small leaks of hydraulic medium, can lead to a drop in pressure in the respective working chamber of the hydraulic length-adjusting apparatus and thus to compressing/rebounding and/or an unwanted lengthwise adjustment of the connecting rod. This problem can increase particularly at high rotational speeds.

The smaller dimensioning to the guide shank enabled by the invention can provide a larger hydraulic working surface on the piston in an inventive connecting rod, in particular on the side of the piston facing the first connecting rod part. The resultant hydraulic pressure ratios on the piston in the hydraulic length-adjusting device when an inventive connecting rod is used in a reciprocating engine can thus be improved, in particular the resulting hydraulic pressures reduced, which can mainly be achieved by a larger second effective hydraulic surface due to a guide shank dimensioned smaller in diameter. In particular, the invention enables the providing of a hydraulic length-adjustable connecting rod with a second effective hydraulic surface size of at least 0.3 times, preferably 0.4 times, in particular at least 0.5 times being possible. As a result, the risk of an unwanted change in the set effective connecting rod length can in turn be reduced or even completely eliminated respectively. In particular, an unwanted change in the set effective connecting rod length due to compression and/or rebound effects caused by the high forces, and consequently high pressures, developing in the combustion chamber of a cylinder of a reciprocating piston internal combustion engine during the combustion process can be reduced and/or even eliminated completely.

In a connecting rod according to the invention, the hydraulic cylinder of the length-adjusting device is preferably situated completely within the connecting rod, in particular within a connecting rod shaft, whereby a connecting rod shaft in the sense of the invention refers to a rod-like section between the piston-side end of the connecting rod and the crankshaft-side end of the connecting rod.

The hydraulic supply necessary for the length-adjusting device is preferably provided via a hydraulic medium feed line, wherein the hydraulic medium feed line can in particular be supplied with hydraulic medium via the crankshaft-side connecting rod bearing.

In a further advantageous configuration of an inventive connecting rod, the second stop surface is a surface extending outwardly from the guide cylinder, preferably a surface extending radially outwardly from the guide cylinder, in particular a circumferentially formed surface.

In a further advantageous configuration of an inventive connecting rod, the second stop surface is at least partly formed by an edge surface of the guide cylinder wall facing the first connecting rod part. The edge surface thereby extends preferably perpendicular to a surface area of the guide cylinder, in particular normal to the longitudinal axis of the connecting rod. The second stop surface can thus be of particularly simple configuration; i.e. the surface of a guide cylinder edge facing the first connecting rod part preferably at least partially forms the second stop surface.

In a further advantageous configuration of an inventive connecting rod, the first stop surface is a surface extending outwardly from the guide shank, preferably a surface extending radially outwardly from the guide shank, in particular a circumferentially formed surface. The first stop surface preferably extends parallel to the second stop surface, in particular normal to a longitudinal axis of the guide shank, particularly preferentially normal to the longitudinal axis of the connecting rod.

In a further advantageous configuration of an inventive connecting rod, the first connecting rod part is of at least two-part design, whereby the first connecting rod part is preferably comprised of at least one first section and the guide shank, and whereby the guide shank is in particular connected to the first section in the area of its end opposite the second connecting rod part. In particular, the guide shank is thereby received by the first section. Preferably, the at least one element of the connecting rod bearing of the first connecting rod part, in particular the small connecting rod eye, is thereby part of the first section of the first connecting rod part.

In a further advantageous configuration of an inventive connecting rod, the guide shank is screwed to the first section in the area of its end opposite the second connecting rod part. Preferably, the guide shank is thereby screwed into the first section of the first connecting rod part, in particular by its end opposite the second connecting rod part. A first connecting rod part can thereby be formed with a guide shank in a particularly simple manner. In particular, a guide shank with low tolerances can thereby be produced in particularly simple manner since it can be fabricated independently of the first section of the first connecting rod part.

In a further advantageous configuration of an inventive connecting rod, the first stop surface of the first connecting rod part is at least partly formed by an edge surface of the wall of a drill hole of the first section of the first connecting rod part facing the second connecting rod part. Preferably, the drill hole in the first section of the first connecting rod part has an inner threading for receiving the guide shank, in particular an inner threading for screwing the first section to the guide shank.

In some cases, it can be advantageous for the second connecting rod part to be of multi-part configuration, whereby it can be particularly advantageous for the guide cylinder to be screwed into a section of the second connecting rod part.

In a further advantageous configuration of an inventive connecting rod, an effective length of the guide shank relative to a depth of the guide cylinder is dimensioned such that when the effective connecting rod length is being shortened, an end of the guide shank facing the second connecting rod part first bottoms with the guide cylinder before the first stop surface rests against the second stop surface.

Within the meaning of the invention, the effective length of the guide shank refers to the distance between the first stop surface, in particular its centroid, and a surface first bottoming with the guide cylinder, in particular its centroid, projected onto the displacement axis of the guide shank relative to the guide cylinder; i.e. measured parallel to the displacement axis of the guide shank, wherein the surface first bottoming with the guide cylinder preferably forms a lowermost end of the guide shank.

To be understood as the depth of the guide cylinder in the sense of the invention is the distance between the second stop surface, in particular its centroid, and a surface first bottoming with the guide shank, in particular its centroid, projected onto the displacement axis of the guide cylinder relative to the guide shank, wherein the surface first bottoming with the guide shank preferably at least partially forms a base of the guide cylinder.

In other words, meaning that in a further advantageous configuration of an inventive connecting rod, the guide shank is preferably slightly longer in dimension than the guide cylinder is deep so that when the effective connecting rod length is being shortened, the guide shank first bottoms with the guide cylinder before the first stop surface of the first connecting rod part bears against the second stop surface of the guide cylinder and/or bottoms with same, whereby the second stop surface is in particular formed by an upper edge of the guide cylinder.

In a further advantageous configuration of an inventive connecting rod, the connecting rod is configured such that the first stop surface does not bottom with the second stop surface until a defined compressive force acting on the connecting rod along the longitudinal axis is reached.

In addition, the effective length of the guide shank relative to the depth of the guide cylinder as well as a diameter of the guide shank are preferably dimensioned and the material properties of the guide shank selected such that after the guide shank bottoming with the guide cylinder, the deformation of the guide shank needed to bring the first stop surface into contact with the second stop surface is not achieved until the defined compressive force is, in particular substantially, reached. The connecting rod is thereby preferably designed, in particular the defined compressive force selected, such that after the guide shank bottoming with the guide cylinder, the first stop surface can be brought into contact with the second stop surface by elastic deformation of the guide shank with the second stop surface. In particular, as of reaching the defined compressive force; i.e. in particular upon exceeding the defined compressive force, a portion of the compressive force acting on the connecting rod along the longitudinal axis of the connecting rod can be transferred past the guide shank via the first stop surface and the second stop surface from the first connecting rod part into the second connecting rod part and/or vice versa.

With such a configuration of an inventive connecting rod, the resulting compressive forces can be advantageously distributed over multiple components of the connecting rod, in particular as circumstances require. The only partial relieving of load on the guide shank lowers the additional load on the remaining components.

In one alternative advantageous configuration of an inventive connecting rod, a compressive force applied to the connecting rod is completely transferred past the guide shank via the first stop surface and the second stop surface from the first connecting rod part into the second connecting rod part and/or vice versa upon the first stop surface lying against the second stop surface.

In a further advantageous alternative configuration of an inventive connecting rod, the effective length of the guide shank is in addition of smaller dimension than the depth of the guide cylinder so that before the end of the guide shank facing the second connecting rod part bottoming with the guide cylinder during the shortening of the effective connecting rod length, the first stop surface lies or comes to rest against the second stop surface. In other words, meaning that in this case, the effective length of the guide shank is preferably of smaller dimension than the depth of the guide cylinder so as to in principle prevent a bottoming between the guide shank and the guide cylinder and so that the first stop surface in particular always abuts against the second stop surface when the effective connecting rod length is being shortened before the end of the guide shank facing the second connecting rod part reaches the base of the guide cylinder (which it in particular never reaches in this specifically described configuration). This can thereby keep the compressive forces acting on the guide shank particularly low and enables a particularly small dimensioning of the guide shank, in particular with respect to its cross section.

If the guide shank and/or the guide cylinder are each screwed in, it is particularly easy to set the effective length of the guide shank and/or the minimum and/or maximum effective connecting rod length, in particular when the guide shank and/or the guide cylinder are of rotationally symmetric configuration; i.e. merely by increased or decreased screwing into the associated connecting rod part section.

A reciprocating piston engine according to the invention is characterized in that it comprises a connecting rod designed in accordance with the invention.

A vehicle with a reciprocating piston engine according to the invention is characterized in that it comprises a reciprocating piston engine according to the invention.

These and further features and advantages are evident from the claims and the description as well as from the drawings, wherein the individual features can in each case be realized on their own or combined in the form of subcombinations in an embodiment of the invention, provided same is technically feasible.

The invention will be described in greater detail in the following on the basis of non-limiting example embodiments as depicted in the figures, whereby components having the same function have the same reference numerals. Shown at least partly schematically in the figures are:

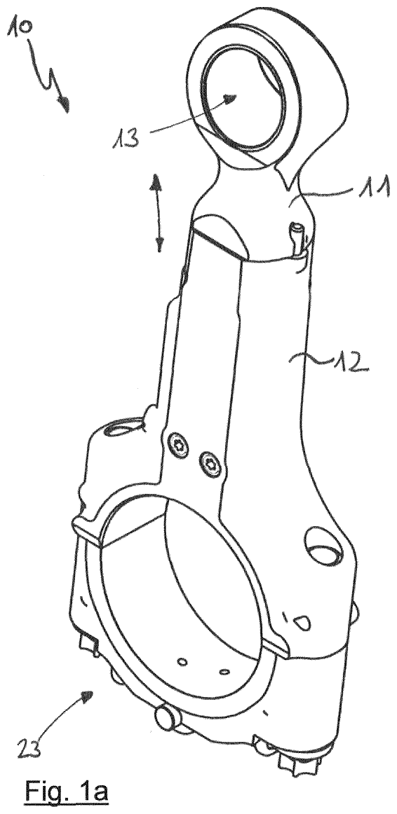

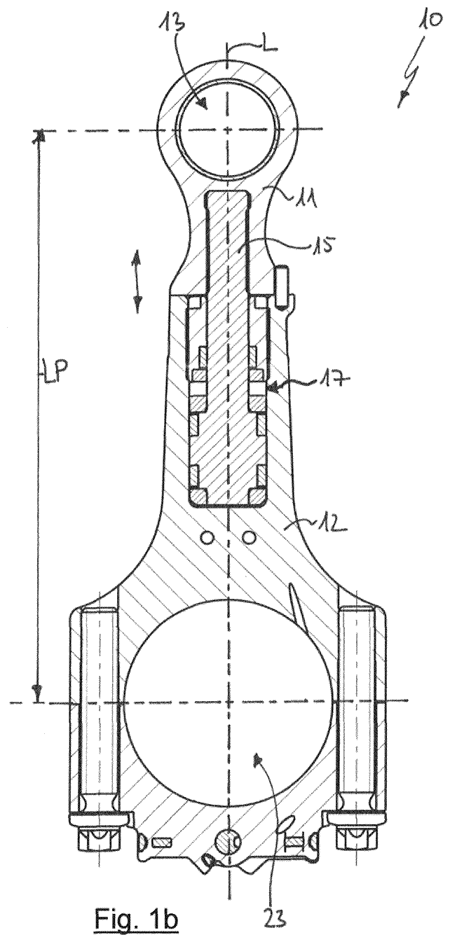

FIG. 1a a first exemplary embodiment of a connecting rod according to the invention in perspective view,

FIG. 1b the inventive connecting rod from FIG. 1a in sectional view,

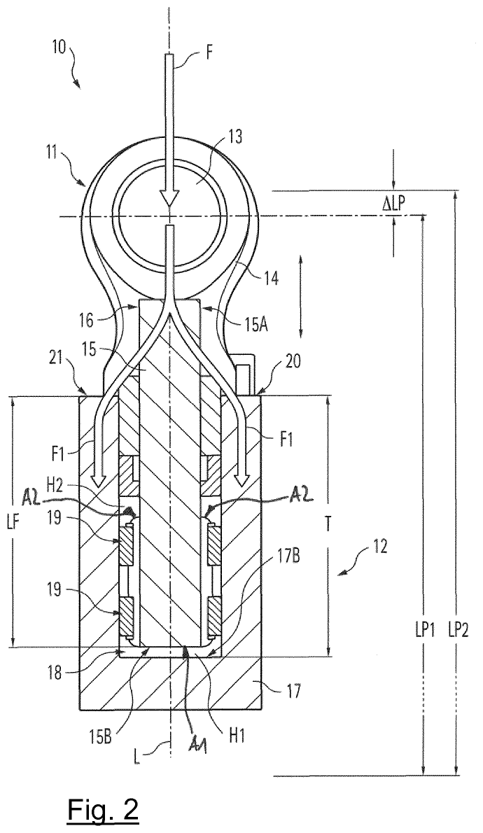

FIG. 2 an enlarged detail of the inventive connecting rod from FIGS. 1a and 1b, likewise in sectional view,

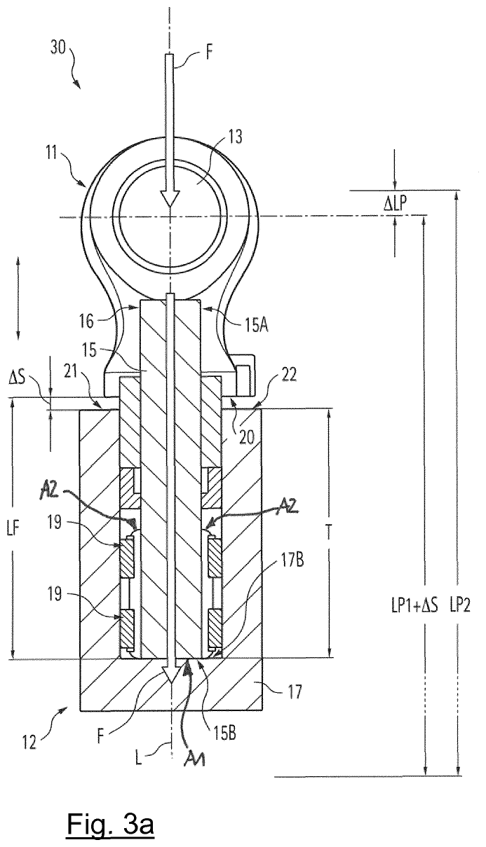

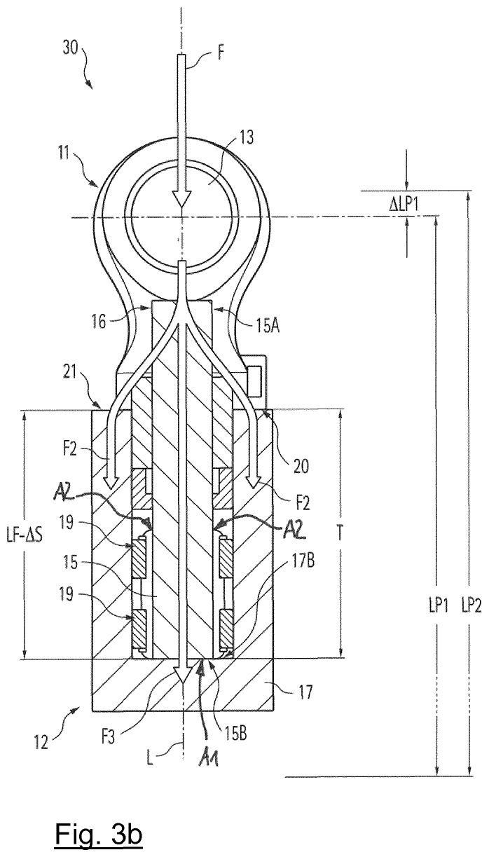

FIG. 3a a detail of a second exemplary embodiment of an inventive connecting rod in a first state, likewise in sectional view, and

FIG. 3b the detail of the connecting rod from FIG. 3a in a second state.

FIG. 1a shows a first exemplary embodiment of an inventive length-adjustable connecting rod 10 having a first connecting rod part 11 as well as a second connecting rod part 12, wherein the first connecting rod part 11 comprises a small connecting rod eye 13 on a first piston-side end for connecting the connecting rod 10 to a reciprocating piston of a reciprocating piston internal combustion engine. At the other crankshaft-side end of the connecting rod 10, the connecting rod 10 has a large connecting rod eye 23 for connecting the connecting rod 10 to a crankshaft of the reciprocating piston engine.

As can be seen from FIG. 1b, the second connecting rod part 12 comprises a section with a guide cylinder 17 on its end facing the first connecting rod part 11. The first connecting rod part 11 has a guide shank 15 of corresponding design to the guide cylinder 17 at its end facing the second connecting rod part 12.

The guide shank 15 is thereby at least partially accommodated by the guide cylinder 17 and can be displaced relative to the guide cylinder 17, or second connecting rod part 12 respectively, along a longitudinal axis L of the connecting rod 10 for adjusting an effective connecting rod length LP relative to said guide cylinder 17, which is indicated in FIG. 1b by the not further specified double arrow. In particular, the guide shank 15 can be pushed into the guide cylinder 17 or respectively pulled out of same. A telescoping of the guide shank 15 and guide cylinder 17 together thereby effects a shortening of an effective connecting rod length LP while a pulling apart or respectively withdrawing of the guide shank 15 from the guide cylinder 17 leads to a lengthening of the effective connecting rod length LP.

The effective connecting rod length LP can thereby be adjusted between a minimum effective connecting rod length LP1 and a maximum effective connecting rod length LP2, which differs by magnitude ΔLP (see e.g. FIG. 2). The effective connecting rod length LP is thereby defined by the distance between the two rotational axes of the connecting rod 10 about which the connecting rod 10 can rotate on the piston side and crankshaft side in a functional state of use.

FIG. 2 shows an enlarged detail of the inventive connecting rod 10 from FIG. 1a and 1b, by means of which it is particularly easy to see how the guide cylinder 17 of the second connecting rod part 12 receives the guide shank 15 of the first connecting rod part 11.

In this exemplary embodiment of an inventive connecting rod 10, the first connecting rod part 11 is of multi-part design and is in particular comprised of a first section 14 comprising the small connecting rod eye 13 as well as the guide shank 15, whereby the first section 14 of the first connecting rod part 11 exhibits a drill hole 16 with an inner threading (not further specified here) into which is screwed a first end 15A of the guide shank 15, wherein the guide shank 15 also comprises a correspondingly designed external threading (not further specified) in this area 15A. In an alternative configuration of an inventive connecting rod, the guide shank 15 can be connected to the first connecting rod part 11 by means of transverse shrink fit; i.e. by means of an interference fit, whereby the guide shank 15 and/or the first section 14 of the first connecting rod part 11, in particular the drill hole 16 in the first connecting rod part 11, is in particular correspondingly larger to that end.

For adjusting the effective connecting rod length, the inventive connecting rod 10 comprises a not further specified hydraulic length-adjusting device having a hydraulic cylinder and a piston able to move relative to each another along a displacement axis to adjust the effective connecting rod length, whereby the displacement axis in this exemplary embodiment of an inventive connecting rod 10 coincides with the longitudinal axis L of the connecting rod and the guide cylinder 17 forms the hydraulic cylinder of the length-adjusting device and the guide shank 15 the piston of the length-adjusting device. The length-adjusting device thereby functions according to the same principle as described in WO 2015/055582 A2 as already mentioned several times above.

The guide cylinder 17 thereby forms the hydraulic cylinder 17 of the length-adjusting device and the guide shank 15 the piston 15, whereby the guide shank 15 is designed as a double-acting or respectively two-stage stepped piston 15 and divides a hydraulic working chamber in the guide cylinder 17 into a first, in this case lower, hydraulic chamber H1 as well as a second, in this case upper, hydraulic chamber H2, wherein appropriate seals 19 are provided for sealing the two hydraulic chambers H1 and H2 from one another and from the guide cylinder 17 at the guide shank 15.

The guide shank 15 designed as a double-acting stepped piston comprises a first effective hydraulic surface A1 and a second effective hydraulic surface A2, whereby the first effective hydraulic surface A1 is allocated to the first hydraulic working chamber H1 of the length-adjusting device and the second effective hydraulic surface A2 to the second hydraulic working chamber H2 and in particular arranged on the side of the guide shank 15 opposite from the free end of said guide shank 15. The size of the second effective hydraulic surface A2 is thereby 0.5 times that of the first effective hydraulic surface A1.

According to the invention, the first connecting rod part 11 comprises a stop surface 20 and the second connecting rod part 12 a second stop surface 21, wherein a lying of the first stop surface 20 against the second stop surface 21 restricts a telescoping of the first connecting rod part 11 and second connecting rod part 12, or guide shank 15 and guide cylinder 17 respectively, and thus a (further) shortening of the effective connecting rod length, whereby this exemplary embodiment of an inventive connecting rod 10 is designed such that the first stop surface 20 lies against/bears on the second stop surface 21 when the minimum effective connecting rod length LP1 has been reached.

According to the invention, upon the first stop surface 20 resting against the second stop surface 21 in this connecting rod 10, a compressive force F acting on the connecting rod 10 along the longitudinal axis L of the connecting rod 10, symbolically represented here by the “F” arrow, is completely transferred past the guide shank 15 via the first stop surface 20 and the second stop surface 21 from the first connecting rod part 11 into the second connecting rod part 12 or vice versa.

In addition, a length LF of the guide shank 15 is dimensioned in relation to a depth T of the guide cylinder 17 such that before the end of the guide shank 15B facing the second connecting rod part 12 reaches a base 17B of the guide cylinder 17 during the shortening of the effective connecting rod length LP (by the telescoping of guide shank 15 and guide cylinder 17), the first stop surface 20 rests against the second stop surface 21.

The connecting rod 10 is in particular designed such that a small gap 18 always remains between the guide shank 15, in particular its lower end 15B, and the base 17B of the guide cylinder 17 so that compressive force F applied on the connecting rod 10 after the minimum effective connecting rod length LP1 has been reached can always be entirely transferred past the guide shank 15 via the first stop surface 20 and the second stop surface 21 from the first connecting rod part 11 into the second connecting rod part 12 and/or vice versa, which is symbolized in FIG. 2 by the F1 arrow. In other words, an inventive connecting rod designed according to the first exemplary embodiment 10 is preferably designed such that even upon possible elastic deformation of the guide cylinder 17 resulting from an extremely high compressive force F, the lower end of 15B of the guide shank 15 does not bottom with and/or abut against the base 17B of the guide cylinder 17. Albeit this is not absolutely imperative. Important is only that the load on the guide shank 15 is sufficiently relieved.

Since the compressive force F acting on the connecting rod 10, which results from the combustion pressure in the associated combustion chamber of the reciprocating piston engine, is at its greatest in the downstroke when a minimum effective connecting rod length LP1 is set and dissipated via the guide cylinder 17 and not via the guide shank 15 in the inventive connecting rod 10 at minimum set effective connecting rod length LP1, a maximum compressive force load acting on the guide shank 15 during the operation of the reciprocating piston engine, in particular maximum compressive force F acting on the guide shank 15 during the operation of the reciprocating piston engine, can be reduced.

Consequently the guide shank 15 itself can be dimensioned smaller, whereby the potential relieving of load on the guide shank 15 made possible by the invention in particular enables reducing the guide shank 15 cross section. A larger hydraulic working surface can thereby be provided above all in the upper hydraulic chamber H2 on the piston 15 formed by the guide shank 15, in particular on the side of the piston 15 facing the first connecting rod part 11. In particular, a second effective hydraulic surface A2 can be provided, its size amounting to at least 0.3 times the first effective hydraulic surface, preferably at least 0.4 times or, as in the present exemplary embodiment, 0.5 times or higher. The resulting hydraulic compression ratios on piston 15 in the hydraulic length-adjusting device during operation can thereby be improved. As a result, the risk of an unwanted change in the set effective connecting rod length LP, in particular an unwanted rebound, can in turn be reduced or even completely eliminated respectively.

There are however limitations set on the smaller dimensioning of the guide shank 15, particularly with regard to buckling and operational stability (HCF=high cycle fatigue), which are in particular defined by the pressure loads resulting at greater effective connecting rod lengths LP. Although the pressure loads occurring at greater effective connecting rod lengths LP are overall lower in the downstroke than at minimum effective connecting rod length LP1, the first stop surface 20 does not lie against the second stop surface 21 at greater effective connecting rod lengths LP such that compressive force F acting on the connecting rod 10 cannot be led off via the guide cylinder 17 but instead entirely via the guide shank 15 and the hydraulic medium is retained in the lower hydraulic chamber H1. Meaning that no relieving of guide shank 15 load is achieved in this case.

FIG. 3a shows a detail of a second exemplary embodiment of an inventive connecting rod 30, wherein the connecting rod 30 is in principle structured exactly the same as the inventive connecting rod 10 described on the basis of FIGS. 1a to 2. Functionally identical components are accordingly provided with identical reference numerals. In the inventive connecting rod 30 depicted in FIG. 3a, however, the length LF of the guide shank 15 relative to the depth T of the guide cylinder 17 is dimensioned differently thereto.

In the exemplary embodiment of an inventive connecting rod 30 depicted in FIG. 3a, the length LF of the guide shank 15 is thereby selected to be larger than the depth T of the guide cylinder 17 by tolerance amount ΔS.

When the effective connecting rod length LP is being shortened by the telescoping of guide shank 15 and guide cylinder 17, the lower end 15B of the guide shank 15 thus first bottoms with the base 17B of the guide cylinder 17; i.e. abuts against same, before the first stop surface 20 rests against the second stop surface 21. In this state, the entire compressive force F applied on connecting rod 30 is transferred from the first connecting rod part 11 via the guide shank 15, in particular to the base 17B of the guide cylinder 17.

If the lower end 15B of the guide shank 15 is resting against the base 17B of the guide cylinder 17, application of a high enough compressive force F leads to an elastic deformation of the guide shank 15, in particular to a compressing of the guide shank 15 along the longitudinal axis L of the connecting rod 30 and thus to an elastic shortening of the guide shank 15 (shortened length=LF minus elastic deformation due to compressive force). As a result, there is a further elastically induced shortening of the effective connecting rod length LP, wherein a gap 22 always remains between stop surfaces 20 and 21 upon elastically induced shortening of the effective connecting rod length LP so that the entire compressive force F continues to be conducted via the guide shank 15.

The inventive connecting rod 30 is thereby designed, in particular the guide shank 15, such that after the guide shank 15 bottoms with the guide cylinder 17, the first stop surface 20 comes into contact and/or bottoms with the second stop surface 21 upon the reaching of a defined compressive force F acting on the connecting rod 30 along the longitudinal axis, which is in particular achieved by a deformation of the guide shank 15 caused by the magnitude ΔS of compressive force F applied along the longitudinal axis L. This state is depicted in FIG. 3b.

The appropriate design to the guide shank 15, in particular appropriately dimensioned length LF as well as appropriately dimensioned cross section and appropriately selected material, allows a regulating of the deformation effected by the application of the defined compressive force F such that a shortening of the guide shank by magnitude ΔS results, in particular as a result of wholly elastic deformation, compare FIG. 3a to FIG. 3b.

At the moment at which a compressive force F acting on the connecting rod 30 reaches the defined compressive force and the first stop surface 20 abuts against the second stop surface 21, a compressive force F applied on the connecting rod 30 is inventively at least partly; i.e. at least a portion of the compressive force F acting on the connecting rod along the longitudinal axis of the connecting rod 30, transferred past the guide shank 15 from the first connecting rod part 11 into the second connecting rod part 12 via the first stop surface 20 and the second stop surface 21, see FIG. 3b.

The portion of compressive force F transferred via stop surfaces 20 and 21 is thereby symbolically depicted in FIG. 3b by the F2 arrows and the remaining potion of compressive force F transferred from the first connecting rod part 11 into the second connecting rod part 12 via guide shank 15 is symbolized by the F3 arrow.

The guide shank 15 being screwed into section 14 of the first connecting rod part 11 and of rotationally symmetric design enables a particularly simple regulating of the effective length LF of the guide shank 15 and it being adapted to the guide cylinder 17 and of regulating the defined compressive force F or respectively setting the deformation ΔS of the guide shank required for bottoming with the stop surfaces 20 and 21.

With the appropriate design of an inventive connecting rod, in particular a correspondingly wide range of permissible guide shank screw engagement depths, an inventive connecting rod having the properties of connecting rod 10 as described on the basis of FIG. 1 or a connecting rod having the properties of connecting rod 30 as described on the basis of FIGS. 2a and 2b can thus be alternatively provided as needed.

Obviously, a plurality of modifications, in particular structural modifications, are possible without departing from the scope of the claims.

### LIST OF REFERENCE NUMERALS

10, 30 inventive length-adjustable connecting rod

11 first connecting rod part

12 second connecting rod part

13 small connecting rod eye

14 first section of first connecting rod part

15 guide shank

15A first end of guide shank

15B second end of guide shank

16 drill hole

17 guide cylinder

17B base of guide cylinder

18 gap

19 seals

20 first stop surface

21 second stop surface

22 gap between first and second stop surface upon the guide shank contacting the guide cylinder

23 large connecting rod eye

A1 first effective hydraulic surface

A2 second effective hydraulic surface

F compressive force

F1, F2, F3 portion of compressive force

H1 first hydraulic chamber

H2 second hydraulic chamber

L longitudinal axis of connecting rod

LF effective guide shank length

PL effective connecting rod length

LP1 minimum effective connecting rod length

LP2 maximum effective connecting rod length

ΔS gap height of the gap between first and second stop surface upon the guide shank contacting the guide cylinder

T guide cylinder depth

What is claimed is:

1. A length-adjustable connecting rod for a reciprocating piston engine, the connecting rod comprising:
a first connecting rod part;
a second connecting rod part, wherein the second connecting rod part has a section with a guide cylinder on its end facing the first connecting rod part,
wherein the first connecting rod part has a guide shank corresponding in form to the guide cylinder on its end facing the second connecting rod part,
wherein the guide shank of the first connecting rod part is at least partly accommodated by the guide cylinder in a functional state of use of the connecting rod and is movable relative to the guide cylinder for adjusting an effective length of the connecting rod,
wherein the first connecting rod part comprises a first stop surface and the second connecting rod part comprises a second stop surface,
wherein the first stop surface lying against the second stop surface restricts a relative movement between the first connecting rod part and the second connecting rod part in a first direction, and
wherein the connecting rod is designed such that when the first stop surface lies against the second stop surface, at least a portion of a compressive force acting on the connecting rod along a longitudinal axis of the connecting rod is transferred past the guide shank via the first stop surface and the second stop surface from the first connecting rod part into the second connecting rod part and/or from the connecting rod part into the first connecting rod part.

2. The connecting rod according to claim 1, wherein the connecting rod is configured such that the first stop surface lying against the second stop surface restricts a relative motion between the first connecting rod part and the second connecting rod part thereby shortening the effective length of the connecting rod.

3. The connecting rod according to claim 1, wherein the first connecting rod part and/or the second connecting rod part comprises at least one element of a connecting rod bearing, wherein the first connecting rod part is constructed to connect to a reciprocating piston of the reciprocating piston engine, and wherein the second connecting rod part is constructed to connect to a crankshaft of the reciprocating piston engine.

4. The connecting rod according to claim 1, wherein the connecting rod comprises a hydraulic length-adjusting device for adjusting the effective length of the connecting rod, wherein the hydraulic length-adjusting device comprises at least one hydraulic cylinder having a first hydraulic working chamber, a second hydraulic working chamber, and a piston, and wherein the piston of the hydraulic length-adjusting device is part of the first connecting rod part and the hydraulic cylinder is part of the second connecting rod part.

5. The connecting rod according to claim 4, wherein the guide cylinder forms the hydraulic cylinder of the hydraulic length-adjusting device and the guide shank forms the piston of the length-adjusting device, and wherein the piston of the hydraulic length-adjusting device divides the hydraulic cylinder of the hydraulic length-adjusting device into the first hydraulic working chamber and the second hydraulic working chamber.

6. The connecting rod according to claim 5, wherein the guide shank is a double-acting piston, and comprises a first effective hydraulic surface and a second effective hydraulic surface, wherein the first effective hydraulic surface is associated with the first hydraulic working chamber of the hydraulic length-adjusting device and the second effective hydraulic surface is associated with the second hydraulic working chamber, and wherein the size of the second effective hydraulic surface is at least 0.3 times that of the first effective hydraulic surface.

7. The connecting rod according to claim 1, wherein the second stop surface is a surface extending outwardly from the guide cylinder.

8. The connecting rod according to claim 1, wherein the second stop surface is at least partly formed by an edge surface of the end of the guide cylinder facing the first connecting rod part.

9. The connecting rod according to claim 1, wherein the first stop surface is a surface extending outwardly from the guide shank.

10. The connecting rod according to claim 1, wherein the first connecting rod part is at least a two-part design, wherein the first connecting rod part is comprised of a first section and the guide shank, wherein the guide shank is connected to the first section in an area of its end opposite the second connecting rod part.

11. The connecting rod according to claim 10, wherein the guide shank is screwed to the first section in the area of its end opposite the second connecting rod part.

12. The connecting rod according to claim 10, wherein the first stop surface of the first connecting rod part is formed by an edge surface of a wall of a drill hole of the first section of the first connecting rod part facing the second connecting rod part.

13. The connecting rod according to claim 1, wherein an effective length of the guide shank relative to a depth of the guide cylinder is dimensioned such that when the effective length of the connecting rod is being shortened, an end of the guide shank facing the second connecting rod part first bottoms with the guide cylinder before the first stop surface rests against the second stop surface.

14. The connecting rod according to claim 1, wherein the connecting rod is configured such that the first stop surface does not bottom with the second stop surface until a defined compressive force acting on the connecting rod along the longitudinal axis is reached.

15. The connecting rod according to claim 1, wherein the compressive force acting on the connecting rod is completely transferred past the guide shank via the first stop surface and the second stop surface from the first connecting rod part into the second connecting rod part and/or from the second connecting rod part into the first connecting rod part upon the first stop surface lying against the second stop surface.

16. The connecting rod according to claim 13, wherein the effective length of the guide shank is of smaller dimension than the depth of the guide cylinder such that before the end of the guide shank facing the second connecting rod part contacts a base of the guide cylinder during the shortening of the effective length of the connecting rod, the first stop surface rests against the second stop surface.

17. A reciprocating piston engine having at least one connecting rod, wherein the connecting rod is designed in accordance with claim 1.

18. A vehicle with a reciprocating piston engine wherein the reciprocating piston engine is designed in accordance with claim 17.
